(19) United States
(12) Patent Application Publication
(10) Pub. No.: US 2011/0132955 A1
(43) Pub. Date: Jun. 9, 2011

(54) PAPER TOWEL DISPENSER

(76) Inventor: Kim ACHTON, Vipperod (DK)

(21) Appl. No.: 12/962,315

(22) Filed: Dec. 7, 2010

(30) Foreign Application Priority Data
Dec. 7, 2009 (FI) 20096293

(51) Int. Cl. B26F 3/02

(52) U.S. Cl. 225/10

(57) ABSTRACT

The invention concerns a paper towel dispenser for dispensing rolled paper web sheet by sheet. The dispenser includes an electrically driven machinery for feeding the paper for displaying a sheet length after the previous length is torn off against a blade at the display opening of the dispenser. Devices are included to command the paper feeding machinery. The devices for commanding the paper feeding machinery include a vibration sensor connected to the blade and generating an electrical signal requesting a further sheet length from the paper feeding machinery.

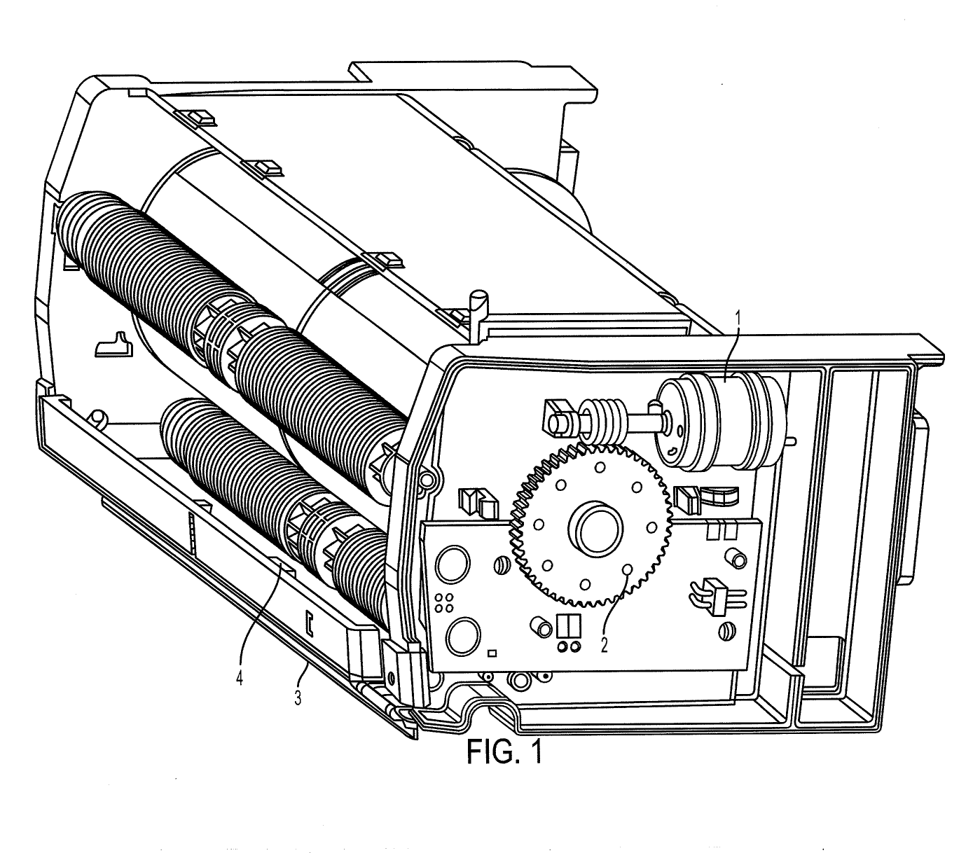

This invention concerns a paper towel dispenser. The dispensing operation is electrically driven and is designed to dispense a one-towel length of paper from a roll occupied in the dispensing apparatus. The consumer is supposed to tear the dispensed length against a blade positioned at the dispensing opening of the apparatus.

For dispensing the paper, the dispensing apparatus includes an electrically driven machinery for achieving an advancement movement of the paper from the roll, in order to display the leading end of the paper from the dispensing opening. The advancement is controlled by a device for displaying a certain length of the paper during each operation cycle of the apparatus. The operation cycle starts when a consumer tears the disposed towel sheet length from the continuous paper web.

A paper towel dispenser following said working schedule is disclosed in US patent specification U.S. Pat. No. 3,730,409. In this know dispenser apparatus the mechanism includes a blade for tearing a dispensed paper length. The blade is mounted on the dispenser to have two positions, a severing position and a rest position. The blade is activated to take the tearing position through tensioning of the paper when a tearing operation is commenced. When swinging between said two positions, the blade acts as a mechanical switch, and causes a switching action to an electrical circuit. This circuit forms in the apparatus an element, which commands the paper feeding devices. This operation mode makes it possible, that the paper is in fact not torn off, only tensioned for tearing, and the system feeds an additional paper length for disposal.

Another system commonly in use includes an electrical detector to detect when a consumer is requesting a towel sheet for use. Usually this detector is a motion detector, which detects hand waving in front of the dispenser. The detector generates an electrical signal commanding the paper feeding apparatus.

The present invention seeks to produce another solution for commanding a paper towel dispenser into a ready-to-use state, in which state a towel length is dispensed and ready to be torn off when a consumer requires paper for wiping. One essential point in the operation of this kind is to detect the actual tearing off of a towel sheet. When the tearing is detected, the apparatus can be commanded to feed a further sheet ready for the next consumer. The operation can be realized in a towel dispensing apparatus including the essential characterizing features disclosed in the appended claim 1.

The invention is explained in more detail with the enclosed drawing FIGURE displaying the main components of the dispensing apparatus of the invention.

The dispenser apparatus shown in the drawing figure includes a space for the paper roll from which the paper web is rolled off stepwise as towel sheets in accordance with the consumption as towel sheets. For dispensing the paper, the apparatus includes an electrically driven motor 1 furnished with an electronic system for commanding the operation of the motor. The motor is connected to a cog-wheel 2 which actually rotates the paper feeding elements resulting that the paper roll occupied in the apparatus receives a rotational movement. The paper feeding elements includes a guiding roll system directing the paper from the roll to an aperture situated in the lower front side of the dispenser. Adjacent to the aperture, the apparatus includes a blade 3, designed to assist in tearing off of the dispensed length of paper across the web direction.

In accordance with the present invention, the blade 3 is furnished with a vibration sensor 4 which is capable of generating an electrical signal when an action is subjected to the blade causing the blade to vibrate. Accomplishing of the present invention presupposes that this action is the tearing of a paper sheet against the blade.

When the system commanding the drive motor 2 receives the signal from the vibration sensor 4, the system rotates the motor for a number of revolutions designed to feed one towel length of the paper web from the dispensing aperture. Then a towel sheet is waiting ready for the next consumer.

The apparatus monitoring the dispensing procedure may further include a detector which is activated by a motion in front of the dispenser, especially when the consumer is waving hand for demanding a towel sheet to be dispensed. In this embodiment of the invention, the signal generated by the vibration sensor is conducted over a time delayer to the devices commanding the dispensing motor. The purpose of the time delayer is that principally only one towel sheet is consumed by each visitor.

The time delayer device may be utilized also in the main embodiment of the invention, i.e. a further sheet is dispensed only after a certain time has elapsed when the vibration sensor detected tearing off of a towel sheet.

The vibration sensor utilized in the invention may be a piezo-electric element, which is known as such in the field of sensing vibrating effects. In order to exclude mal-functions of the system in that sense that the system would deliver a towel sheet each time the dispenser is subjected to an action generating vibration in the construction, the electric circuit may include an electronic filter. This filter is able to separate the vibration caused by the actual tearing from other vibration applied to the system.

The motion detector is preferably a capacitive motion detector, utilized for activation of dispensing apparatuses.

The power for the dispenser may be supplied from batteries or usual electrical power supply network.

1. A dispenser for dispensing paper towels sheet by sheet from a paper web roll, which dispenser includes an electrically driven feed machinery for feeding the paper web from the roll for displaying a paper web sheet length after the previous length is torn off by a consumer , devices to command the feed machinery, and a blade to cut the displayed sheet length from the paper web when the consumer tears off a sheet from the web, wherein the devices for commanding the feed machinery include a vibration sensor for the blade, the sensor generating an electrical signal initiating a request for a further sheet length from the feed machinery.

2. A paper towel dispenser according to claim 1, wherein the vibration sensor is a piezo-electric element.

3. A paper towel dispenser according to claim 1, wherein the signal from the vibration sensor is connected to the feed machinery over an electronic frequency filter.

4. A paper towel dispenser according to claim 1 wherein the electric signal generated by the vibration sensor is connected over a time delay element to the feed machinery.

5. A paper towel dispenser according to claim 1, wherein the feed machinery is further connected to a motion detector for an alternative request for a further sheet length.
